(19) United States
(12) Patent Application Publication
(10) Pub. No.: US 2026/0254749 A1
(43) Pub. Date: Aug. 27, 2026

(54) AVOIDING MICRO-LOOPS AND BLACK-HOLING OF TRAFFIC DURING LINK UP EVENTS IN COMMUNICATIONS NETWORKS, SUCH AS SEGMENT ROUTING NETWORKS FOR EXAMPLE

(71) Applicant: Juniper Networks, Inc., Sunnyvale, CA (US)

(72) Inventors: Shraddha Hegde, Bangalore (IN); Bharath RadhaKrishna Bhat, Bangalore (IN)

(21) Appl. No.: 19/181,890

(22) Filed: Apr. 17, 2025

(30) Foreign Application Priority Data
Feb. 27, 2025 (IN) 202541017367

(51) Int. Cl. H04L 45/00

(52) U.S. Cl. CPC H04L 45/22

(57) ABSTRACT

Methods and devices are described for avoiding micro-loops and black holing in an interior gateway protocol (IGP) domain in which a link is newly UP.

### § 1. RELATED APPLICATION(S)

The present application claims priority benefit to Indian Provisional Application No. 202541017367, filed on Feb. 27, 2025, titled “AVOIDING MICRO-LOOPS AND BLACK-HOLING OF TRAFFIC DURING LINK UP EVENTS IN SEGMENT ROUTING NETWORKS”, and listing Shraddha Hegde and Bharath RadhaKrishna Bhat as the inventors.

### § 2. BACKGROUND OF THE INVENTION

### § 2.1 Field of the Invention

The present application concerns communications networks. More specifically, the present application concerns avoiding micro-loops and/or traffic black-holing in communications networks.

### § 2.2 Background Information

Any information discussed in this section is not to be construed as an admission of prior art.

### § 2.2.1 The Problem of Micro-Loops

In an Interior Gateway Protocol (IGP) network, when a network change event (e.g., link-down, link-up, link metric change, etc.) occurs, it is possible that different routers update their Forwarding Information Base (“FIB”) at different times. This can lead to packets looping between upstream and downstream routers for a transient time. Such transitory looping (referred to as a “micro-loop” or “micro-looping”) can lead to bandwidth wastage, delay, and/or jitter. For the duration of the micro-loop, the affected link between the upstream and downstream routers can get inundated by packets going back and forth to such an extent that it can drop (e.g., almost all) traffic. This can have a cascading impact if control packets are also dropped and control sessions between routers get torn down. This has occurred in actual deployments.

FIG. 1A illustrates routers R0-R5 (130a-130f) in a network topology between a source device(S) 110 and a destination device (D) 120. Each of the links has a cost metric of 10, except for the link from R4 to R3 (referred to as “link R4→R3”), which has a cost metric of 60. In FIG. 1A, before the failure of link R2→R3, the shortest (lowest cost) path from the source device(S) 110 to the destination device (D) 120 is S→R0→R1→R2→R3→D. After the failure of link R2→R3, micro-loops may occur in certain scenarios. As one example, if R0 130a updates its forwarding state before R5 130f, packets will loop between R0 130a and R5 130f as shown by the dotted line path because the shortest path from R5 130f to the destination device 120 will be back through R0 130a (since the FIB of R5 130f is not up-to-date in this example). As another example, referring to FIG. 1B, if both R0 130a and R5 130f have updated their forwarding states, but R4 130e has not, packets will loop between R4 130e and R5 130f as shown by the dotted line path because the shortest path from R4 130e to R3 130d is back through R5 130f (since the FIB of R4 130e is not up-to-date in this example).

### § 2.2.2 Conventional Solution(s) To Micro-Loop Avoidance

The draft document, Ahmed Bashandy, et al, “Loop avoidance using Segment Routing,” draft-bashandy-rtgwg-segment-routing-uloop-17 (Internet Engineering Task Force, Jun. 29, 2024)(incorporated herein by reference and referred to as “the Bashandy draft”) proposes a mechanism aimed at providing loop avoidance in the case of an IGP network convergence event. The solution proposed in the Bashandy draft relies on the temporary use of segment routing (“SR”) policies ensuring loop-freeness over the post-convergence paths from the converging node to the destination.

If the mechanism proposed in the Bashandy draft where applied to the scenarios discussed above with reference to FIGS. 1A and 1B, R0 130a computes a micro-loop avoidance (“MLA”) path to destination device D 120 as a shortest path in network after failure of the R2→R3 link. More specifically, R0 130a computes and applies a Segment Routing Multiprotocol Label Switching (“SR-MPLS”) label stack or an Internet Protocol version 6 Segment Routing Header (“SRv6 SRH”) to ensure that traffic follows the MLA path independent of when other routers update their FIBs to take into account the failure of the R2→R3 link. For example, in FIG. 1A or 1B above, responsive to the failure of R2→R3 link, R0 130a computes the MLA path to destination device D 120 as the segments:
Node-SID R4 (See the dotted line path in FIG. 2A.); and
Adjacency-SID R4→R3 (See the dashed line path in FIG. 2A.).

In this way, even if R5 130f hasn't converged (that is, if the FIB in R5 130f is not completely updated), the packets bound to destination device D 120 will have the node-SID R4 as the top SID and will therefore be “steered” to R4 130e via a shortest path first (“SPF”) path (also referred to as the “lowest cost” path first). Upon a packet destined for destination device D 120 reaching R4 130e, it will be forwarded out R4→R3 link due to the Adjacency-SID R4→R3 segment. To reiterate, this steering of the packet is illustrated in FIG. 2A.

### § 2.2.3 Potential Problems With Conventional Micro-Loop Avoidance Solution(s)

The present inventors have recognized that potential problems can occur if the mechanism in the Bashandy draft is applied to link-up events (that is, a network state change due to a link that has just come up). The potential problem(s) are discussed with reference to FIG. 2B. More specifically, the present inventors have recognized that if the mechanism in the Bashandy draft, used for a link-down event, is also applied to link-up events, problems can arise. For example, referring to FIG. 2B, when R0 130a detects R2→R3 link-up (depicted as an upward pointing arrow in FIG. 2B), it tries to steer packets destined for destination device D 120 over the post-convergence path (Node-SID R2 (shown as a dotted line path in FIG. 2B), Adjacency-SID R2→R3 (shown as a dashed line path in FIG. 2B)). This is simply the post-convergence path with additional SIDs. Note that public documentation by CISCO also indicates it uses the same micro-loop avoidance solution for both link-down and link-up events. (See, e.g., the webpage, https://www.cisco.com/c/en/us/td/docs/ios-xml/ios/seg_routing/configuration/xe-16-12/segrt-xe-16-12-book/sr-is-is-uloop-aviodance.pdf, Pages 4, 5).

A problem with using post-convergence paths for link-up events is now discussed. As recognized by the present inventors, for many routers, especially lower-end routers and/or routers experiencing a high workload, the significant portion of (e.g., most) micro-loop causing delays is not in route-calculation or link-up advertisements. Rather, the present inventors have recognized that the significant portion of (e.g., most) micro-loop causing delays is in programing the FIB. Still referring to FIG. 2B, when the R2→R3 link comes up, it is possible that following sequence of events happens:
1. R2→R3 link comes up.
2. R2 and R3 advertise their link pieces.
3. R0 receives the updated label switched paths (“LSPs”), and computes the MLA path (Node-SID R2, Adjacency-SID R2→R3).
4. A packet destined for D reaches R2 with R2→R3 adjacency-SID.
5. R3 hasn't updated the FIB with R2→R3 adjacency-SID yet.

The above sequence of events 1 through 5 leads to packet “blackholing” at R2 130c.

Basically, even if an MLA solution that guides the packet via post-convergence path using additional SIDs is used, the packets destined for destination device D 120 can get black-holed due to delayed FIB programming. This problem is very pertinent to adjacency SIDs.

The above sequence of events is not uncommon for slow routers, especially if the link which comes up belongs to an ingress PE, connected to a traffic source. Therefore, an improved technique(s) for responding to a link-up event, which avoids micro-loops and/or black-holing, is needed.

### § 3. SUMMARY OF THE INVENTION

An example computer-implemented method is provided for avoiding micro-loops and/or black holing in an interior gateway protocol (IGP) domain in which a link is newly UP. The example computer-implemented method includes: (a) treating the newly UP link as either (A) unusable or (B) as having a very high cost metric, until a delay condition occurs, such that forwarding through the newly UP link is avoided until the delay condition occurs; (b) determining whether or not the delay condition occurs; and (c) responsive to a determination that the delay condition occurs, treating the newly UP link as usable, and using an actual cost metric for the newly UP link. In some example implementations of the example method, the delay condition is the expiration of a timer. As one example, the timer is configured to expire in at least 30 seconds. In some other example implementations, the delay condition is the receipt of a control plane message indicating that one or more nodes in the IGP domain has programmed their forwarding information base (FIB) with the newly UP link.

Another example computer-implemented method is provided for avoiding micro-loops and/or black holing in an interior gateway protocol (IGP) domain in which a link is newly UP. The other computer-implemented method includes: (a) determining a guided path that avoids the newly UP link; (b) determining whether or not a delay condition occurs; and (c) responsive to a determination that the delay condition occurs, removing the guided path. In some example implementations of this other example method, the guided path tunnels packets towards a destination, up to a node that will forward the packets via a shortest path first (SPF) path towards the destination without looping back the packets. In some example implementations of this other example method, the guided path includes at least one prefix/node segment to a node that will forward packets via a shortest path first (SPF) path towards a destination without looping back the packets.

In some example implementations of the other example method, the delay condition is the expiration of a configurable timer. For example, in some example implementations of the other example method, the configurable timer is configured to expire in at least 30 seconds. In some other example implementations of the other example method, the delay condition is the receipt of a control plane message indicating that one or more nodes in the IGP domain has programmed their forwarding information base (FIB) with the newly UP link.

In some example implementations of the other example method, the guided path includes at least one segment routing (SR) segment.

Unlike prior methods that use the same procedure for network changes regardless of whether the change is due to a link being newly UP, or a link being newly DOWN, an example computer-implemented method is provided for avoiding micro-loops and/or black holing in an interior gateway protocol (IGP) domain in which a network change event occurs, the computer-implemented method comprising: (a) responsive to a determination that a link in the IGP domain is newly DOWN, determining a temporary micro-loop avoidance (MLA) path using a first procedure; and (b) responsive to a determination that a link in the IGP domain is newly UP, determining a temporary micro-loop avoidance (MLA) path using a second procedure which is different than the first procedure. The second procedure may be, for example, any of the example computer-implemented methods summarized above, or described elsewhere in this application.

A network node (e.g., a router, a switch, etc.) may be configured to perform any of the computer-implemented methods summarized above, or described elsewhere in this application. The network node may include at least one processor, and a storage system storing processor-executable instructions which, when executed by the at least one processor, cause the at least one processor to perform any of the example methods summarized above, or described elsewhere in this application.

A non-transitory computer-readable medium storing processor-executable instructions for performing any of the example methods summarized above, or described elsewhere in this application, is provided. For example, the non-transitory computer-readable medium may store processor-executable instructions which, when executed by at least one processor, cause the at least one processor to perform any of the example methods summarized above, or described elsewhere in this application.

### § 4. BRIEF DESCRIPTION OF THE DRAWINGS

FIGS. 1A and 1B illustrate the problem of micro-loops in a network topology between a source device and a destination device.

FIG. 2A illustrates the steering of a packet in a conventional micro-loop avoidance technique, and FIG. 2B illustrates potential problems that can occur if the conventional micro-loop avoidance technique is applied to link-up events (that is, a network state change due to a link coming up).

FIG. 3 is a flow diagram of a first example method for avoiding micro-loops and black holing in an interior gateway protocol (IGP) domain in which a link is newly UP.

FIG. 4 is a flow diagram of a second example method for avoiding micro-loops and/or black holing in an interior gateway protocol (IGP) domain in which a link is newly UP.

FIG. 5 illustrates segments used to guide packets in an example operation of the second example method.

FIG. 6 is an example network used to illustrate an SR domain.

FIG. 7 is an example network used to illustrate SR paths through an SR domain.

FIG. 8 is an example network used to illustrate adjacency segments in an SR domain.

FIGS. 9A and 9B are an example network used to illustrate prefix segments in an SR domain.

FIG. 10 illustrates two data forwarding systems, which may be used as nodes, coupled via communications links, in a communications network.

FIG. 11 is a block diagram of a router which may be used a communications network.

FIG. 12 is a block diagram of an exemplary machine that may perform one or more of the processes described, and/or store information used and/or generated by such processes.

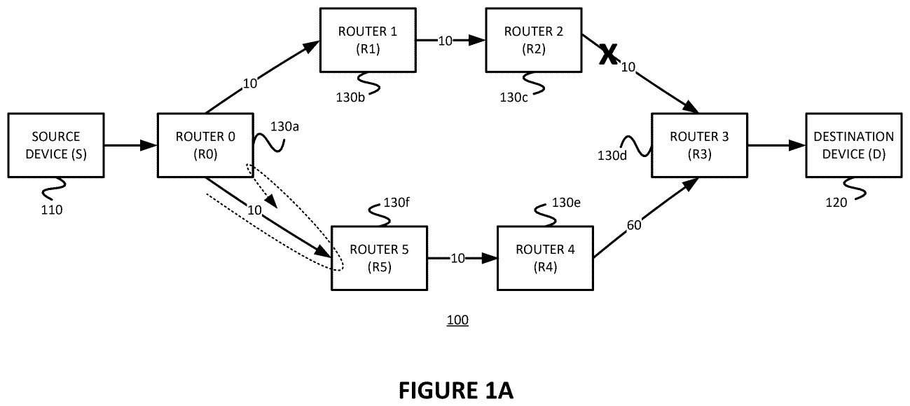

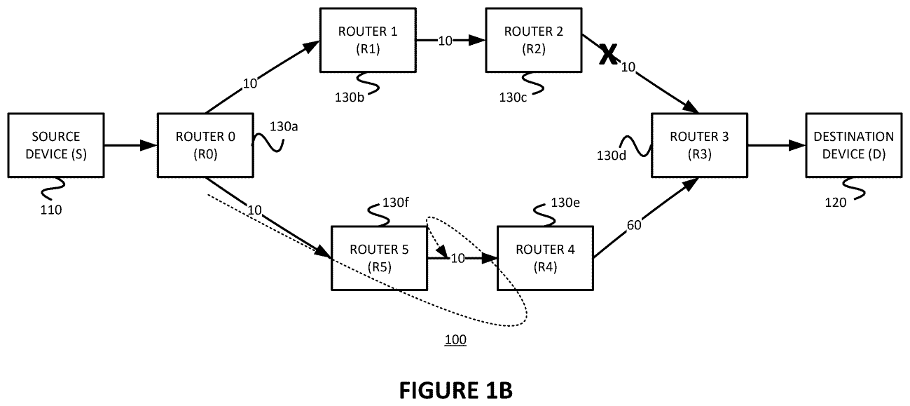

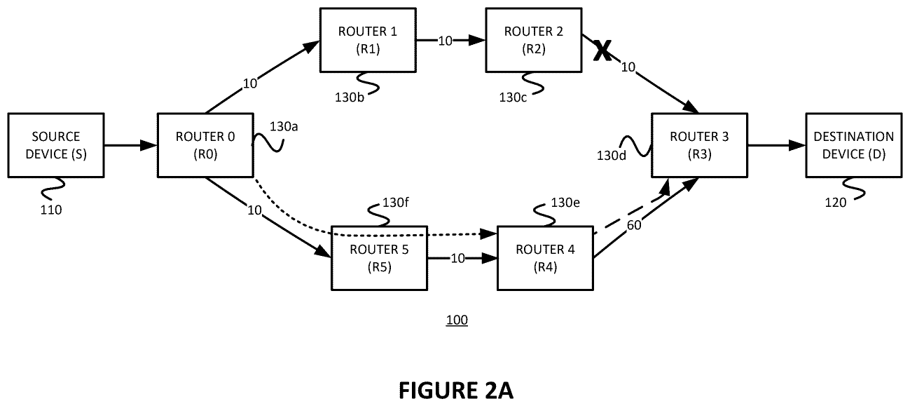

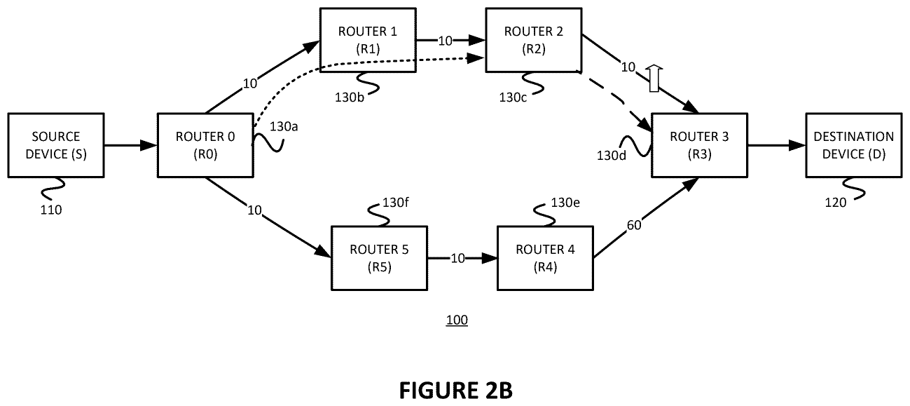

### § 5. DETAILED DESCRIPTION

The present disclosure may involve novel methods, apparatus, message formats, and/or data structures to respond to a link-up event in a way that avoids micro-loops and/or black-holing. The following description is presented to enable one skilled in the art to make and use the described embodiments, and is provided in the context of particular applications and their requirements. Thus, the following description of example embodiments provides illustration and description, but is not intended to be exhaustive or to limit the present disclosure to the precise form disclosed. Various modifications to the disclosed embodiments will be apparent to those skilled in the art, and the general principles set forth below may be applied to other embodiments and applications. For example, although a series of acts may be described with reference to a flow diagram, the order of acts may differ in other implementations when the performance of one act is not dependent on the completion of another act. Further, non-dependent acts may be performed in parallel. No element, act or instruction used in the description should be construed as critical or essential to the present description unless explicitly described as such. Also, as used herein, the article “a” is intended to include one or more items. Where only one item is intended, the term “one” or similar language is used. Thus, the present disclosure is not intended to be limited to the embodiments shown and the inventors regard their invention as any patentable subject matter described.

### § 5.1 Example Methods

The two independent, yet complimentary, example solutions to the problem(s) illustrated above are described below.

### § 5.1.1 First Example Method

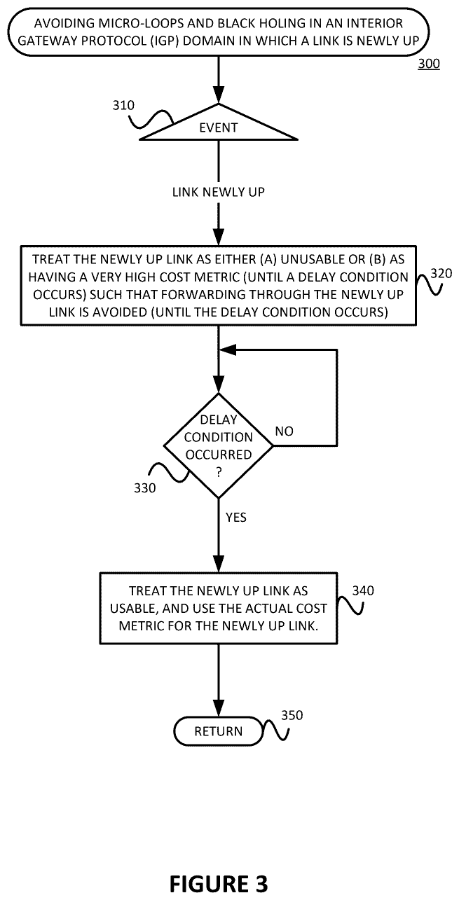

FIG. 3 is a flow diagram of a first example method 300 for avoiding micro-loops and black holing in an interior gateway protocol (IGP) domain in which a link is newly UP. The main acts of the example method 300 are performed when a link is newly UP. (Event 310) Responsive to the link being newly UP, the example method 300 includes treating the newly UP link as either (A) unusable or (B) as having a very high cost metric (until a delay condition occurs). (Block 320) Responsive to the delay condition occurring (Decision 330=YES), the example method 300 then treats the newly UP link as usable, and uses the actual (not the inflated) cost metric for the newly UP link (Block 340). The example method 300 is then left. (Return Node 350) In this way, the example method 300 avoids having nodes forward packets through the newly UP link until the delay condition occurs. Referring back to decision 330, in some example implementations, the delay condition is an expiration of a timer (e.g., at least 30 seconds). In some other example implementations, the delay condition is the receipt of a control plane message indicating that one or more nodes in the IGP domain has programmed its FIB with the newly UP link.

Thus, when a link comes up afresh (detected by adjacency newly coming up), IGPs can temporarily make the link either: (A) unusable for transit (e.g., using link-overload mechanism); and/or (B) less likely to be used for transit (e.g., by advertising the link with a maximum (or otherwise substantially inflated) cost metric). Either can be done for a transient time period (e.g., to allow even slower or burdened routers to have time to update their FIB). After that period, the router may start advertising the real metric for the newly up link. For example, the router may start advertising real metric for the newly up link after expiration of a configurable timer (e.g., with a default of 30 seconds). As another example, the router may start advertising the real metric for the newly up link after the router's control plane has received (e.g., responsive to the control plane receiving) some indication of the newly up link being now usable for transit traffic. For example, this control plane indication might be an acknowledgement for successful programing of the adjacency-route.

This first example method has several advantages. First, it (when a maximum cost link metric is advertised) ensures that the newly up link is used for transit only if there is no other path available to a destination. Second, it is a more targeted approach compared to overall route-programing delay approaches that might lead to slower convergence in case of link-down events. Third, this approach has some commonalities with LDP-IGP synchronization (See, e.g., the document, M. Jork, et al, “LDP IGP Synchronization,” Request for Comments: 5443 (Internet Engineering Task Force, March 2009)(referred to as “RFC 5443” and incorporated herein by reference), which network deployments have successfully employed for several years and are comfortable with.

It should be noted that once the true metric of the newly up link is advertised, micro-loops might still occur if different routers converge at different times. So, it is highly recommended to have micro-loop avoidance solutions on all the nodes (routers) to avoid micro-loops. However, these micro-loop avoidance solutions can be traditional micro-loop avoidance solutions that take guided post-convergence paths.

It is highly recommended that this first example method be implemented on all routers (e.g., or at least one all routers that are known or believed to be slow (e.g., in terms of programming their FIBs)), and not just on ingress provider edge (PE) routers which are computing the routes.

### § 5.1.2 Second Example Method

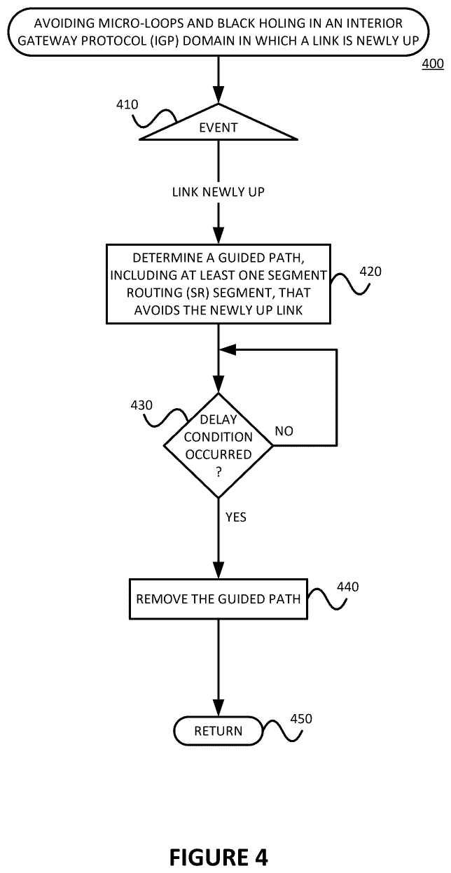

FIG. 4 is a flow diagram of an example method 400 for avoiding micro-loops and/or black holing in an interior gateway protocol (IGP) domain. As shown, the main acts of the example method 400 are performed responsive to a link being newly up. (Event 410) Responsive to a link being newly up, the example method 400 determines a guided path (e.g., including at least one segment routing (SR) segment) that avoids the newly up link. (Block 420). It is then determined whether or not a delay condition occurs. Responsive to a determination that the delay condition occurs (Decision 430=YES), the example method 400 removes the guided path. (Block 440) The example method 400 is then left. (Return Node 450)

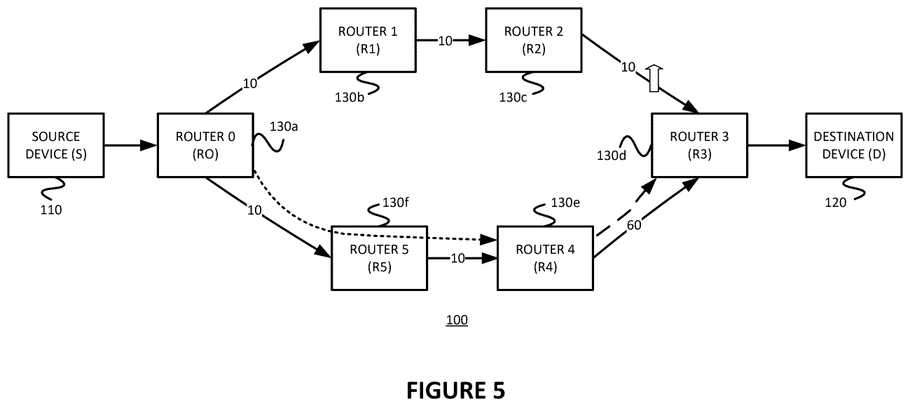

In some example implementations, the guided path tunnels packets towards a destination, up to a node that will forward the packets via a shortest (lowest cost) path first (SPF) path towards the destination without looping back the packets. In some example implementations, the guided path includes at least one prefix/node segment to a node that will forward packets via a shortest (lowest cost) path first (SPF) path towards a destination without looping back the packets. This is illustrated, for example, by the segments in FIG. 5 depicted by a dotted line path, and a dashed line path.

In at least some example implementations, the delay condition is the expiration of a configurable timer. For example, the configurable timer may be configured to expire in at least 30 seconds. In at least some other example implementations, the delay condition is the receipt of a control plane message indicating that one or more nodes in the IGP domain has programmed their FIB with the newly up link. In some example deployments, the delay condition may be configured independently for each of a plurality of nodes in the IGP domain.

Therefore, using the second example method, a node computing a Micro-Loop-Avoiding (MLA) path provides a guided path, avoiding the link that has newly come up (until a delay condition is met), instead of providing a guided post-convergence path as in conventional techniques. This guided path may be, topologically, the same as the current primary path, but might have additional SR segment identifiers (“SIDs”) to guide or steer the packet via the existing primary path. This guided path will ensure that no downstream node streams traffic via the link that newly came up. Note that since the current primary path was not looping, using additional SIDs to force the traffic via the current primary path ensures that no routers loop the packet, irrespective of whether or not they have processed the new link up event. Upon the occurrence of some delay event (e.g., the expiration of a configurable timer, the receipt of some indication of FIB programming completion, etc.), a path including the newly up link can be used. For example, the forced (steered) path may be timed out.

Similar to an example MLA solution described below, the guided post-convergence path should be modified to normal post-convergence path after the expiration of an MLA timer.

In FIG. 5, when R2→R3 link is not yet up, a tunneled route to R3 130d on R0 130a would be:
R0→{node_sid_R3}, via R0→R5 Link.

Topologically, the actual path traversed is R0→R5→R4→R3. When, R3 130d learns that the R2→R3 link has come up, the following path is to be installed:
R0->{Node_SID_R4} (See the dotted path in FIG. 5.),
Adj_SID_R4→R3 (See the dashed path in FIG. 5,)], via R0→R5 link

Topologically, actual path traversed is: R0→R5→R4→R3.

The present inventors'second solution to compute the MLA path that avoids the newly up link follows this idea:
1. Consider the newly up (R2→R3 in the example topology) link as part of the reference/base topology.
2. Compute an MLA path by marking the newly-up link (R2→R3 in the example topology) as “down”, thereby rendering it unusable. In this way, the second solution steers the computation towards any MLA computation procedure (such as the example MLA computation procedure described below), wherein the MLA algorithm avoids a particular link in the topology and provides a guided path towards the destination. The present inventors'second solution leverages any MLA computation procedure (such as the example MLA computation procedure described below) to provide micro-loop avoidance paths for link-down events.

The present inventors'second solution avoids both black-holing and micro-loops as follows. The second solution explicitly avoids the link coming up by considering it to be “down”. This achieves the dual objective of avoiding black-holing and micro-loops as follows. First, since the link coming up is fully avoided, there is no black-holing. Second, the path computed is a guided path, which tunnels the packet up to a node which will forward the packet, via a lowest cost (e.g., SPF) path, towards the destination without looping back the packet. In essence, the algorithm just sees the newly coming up link as “down”, and can use any MLA computation procedure such as the example MLA computation procedure described in § 5.1.4 below, which has already been demonstrated to avoid micro-loops.

Note that some network administrators might still prefer their MLA paths to use the newly up link (e.g., in a deployment in which they are confident that none of their devices are slow in FIB programing). Therefore, it might be useful to invoke the second example method only via a new configuration “knob” or “command”. That is, in some example deployments of the second solution, each node in a first set of at least one node, implements the solution, but each node in a second set of at least one node treats a newly up link per the IGP. In such a deployment, it would be expected that each of the at least one node of the second set is capable of programming its forwarding information base (FIB) faster than each of the at least one node of the first set.

### § 5.1.2.1 Segment Routing

Although segment routing, adjacency segments, and prefix segments are well-understood, it is introduced here for the reader's convenience. The Internet was initially designed to provide best-effort connectivity over a least-cost path. In today's Internet, however, many applications require more than best-effort connectivity over a least-cost path. Today, network operators are tasked with delivering advanced services such as traffic engineering and fast reroute at scale. To deliver these advanced services at scale, network operators must reduce network complexity. Segment Routing (SR) offers an innovative approach to traffic steering. It can be applied to long-standing problems such as traffic engineering and fast reroute. When applied to these problems, SR can simplify routing protocols, network design and network operations.

Segment routing (also referred to as Source Packet Routing in Networking (“SPRING”)) is a control-plane architecture that enables an ingress router to steer a packet through a specific set of nodes and links in the network without relying on the intermediate nodes in the network to determine the actual path it should take. In this context, the term “source” means the point at which the explicit route is imposed. Segment routing is defined in “Segment Routing Architecture,” Request for Comments 8402 (July 2018, the Internet Engineering Task Force) (referred to as “RFC 8402” and incorporated herein by reference). SPRING enables automation of a network by using a software-defined network (“SDN”) controller for traffic steering and traffic engineering in a wide area network (“WAN”) packet network.

Segment routing leverages the source routing paradigm. A node steers a packet through an ordered list of instructions, called “segments.” For example, an ingress router (also referred to as “a headend router”) can steer a packet through a desired set of nodes and links by prepending the packet with segments that contain an appropriate combination of tunnels.

### § 5.1.2.1.1 SR Domain

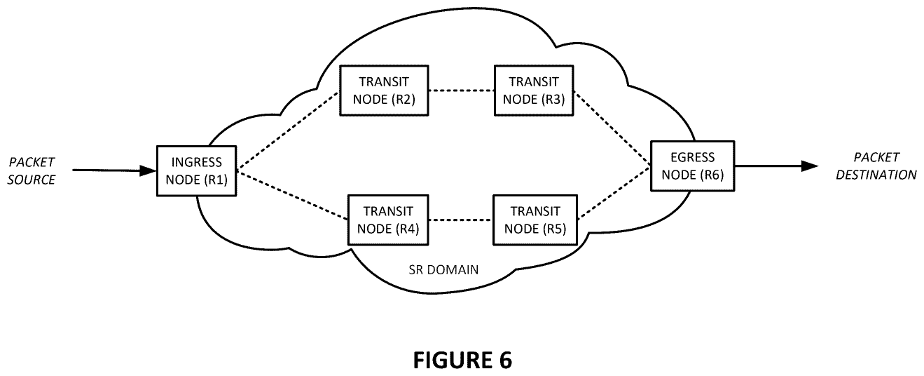

An SR domain is a collection of nodes that participate in SR protocols. Within an SR domain, a node can execute ingress, transit, or egress procedures. FIG. 6 depicts a network in which a source node sends a packet to a destination node. The source and destination nodes reside outside of the SR domain, but the path between them traverses the SR domain. More specifically, when the packet arrives at the SR ingress node (R1), the ingress node subjects the packet to policy. Policy can associate a packet with an SR path. Policy includes match conditions and actions. If the packet satisfies match conditions, the SR ingress node (R1) can encapsulate the packet in an SR tunnel. The SR tunnel traverses an SR path to the egress node (R6).

The SR path can be engineered to satisfy any number of constraints (e.g., minimum link bandwidth, maximum path latency). While an SR path can follow the least cost path to the egress node, constraints can cause it to follow another path.

The source node and the SR ingress node may reside on independent hardware platforms (e.g., on a laptop and a router, respectively), or the source node and SR ingress node can reside on the same hardware (e.g., on a virtual machine and a hypervisor, respectively). Similarly, the SR egress node and the destination node can reside on independent hardware platforms, or on a single platform. In a less typical configuration, the source node resides within the SR domain. In this case, the source node is also the SR ingress node, because it executes SR ingress procedures Similarly, the destination node can reside within the SR domain, in which case, the destination node is also the SR egress node, because it executes SR egress procedures.

### § 5.1.2.1.2 SR Path

An SR path is an ordered list of segments that connects an SR ingress node to an SR egress node. Although an SR path can follow the least cost path from ingress to egress, it can follow another path instead.

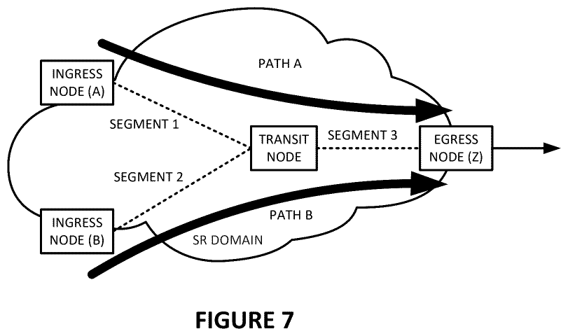

Different SR paths can share the same segment. For example, referring to FIG. 7, Path A connects ingress node A to egress node Z, while Path B connects ingress node B to the same egress node Z. Both paths A and B traverse Segment 3.

When an SR ingress node encapsulates a packet in an SR tunnel, it encodes the associated segment list in the tunnel header. It then forwards the packet downstream. Transit nodes process the tunnel header, forwarding the packet from the current segment to the next segment. Since the SR ingress node encodes path information in the tunnel header, transit nodes do not need to maintain information regarding each path that they support. Rather, the transit nodes are only required to process the tunnel header, forwarding the packet from the current segment to the next segment. This is a major benefit of SR. More specifically, since transit nodes are not required to maintain path information, overhead associated with maintaining that information is eliminated, routing protocols are simplified, scaling characteristics are improved, and network operations become less problematic.

### § 5.1.2.1.3 SR Segments and Segment Types

An SR segment is an instruction that causes a packet to traverse a section of the network topology. While a segment (i.e., an instruction) causes a packet to traverse a section of the network topology, it is distinct from that section of the network topology. SR defines many different SR segment types. Among these are the “adjacency segments” and “prefix segments.” Each of these types of segments is described below.

### § 5.1.2.1.3.1 Adjacency Segments

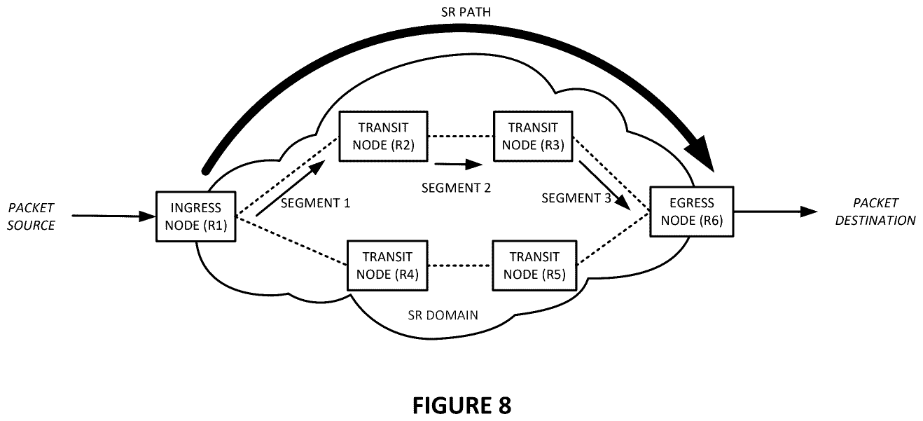

An adjacency segment is an instruction that causes a packet to traverse a specified link (i.e., a link that is associated with an IGP adjacency). FIG. 8 depicts an SR path that connects ingress node R1 to egress node R6. The path contains the following adjacency segments: (1) segment 1, instantiated on R1, causes packets to traverse link R1->R2; (2) segment 2, instantiated on R2, causes packets to traverse link R2->R3; and segment 3, instantiated on R3, causes packets to traverse link R3->R6. If any of the above-mentioned links becomes unavailable, so does the associated adjacency segment. Consequently, if any of the above-mentioned adjacency segments becomes unavailable, so does the entire path.

Thus, an adjacency segment is a strict forwarded single-hop tunnel that carries packets over a specific link between two nodes, irrespective of the link cost.

### § 5.1.2.1.3.2 Prefix Segments

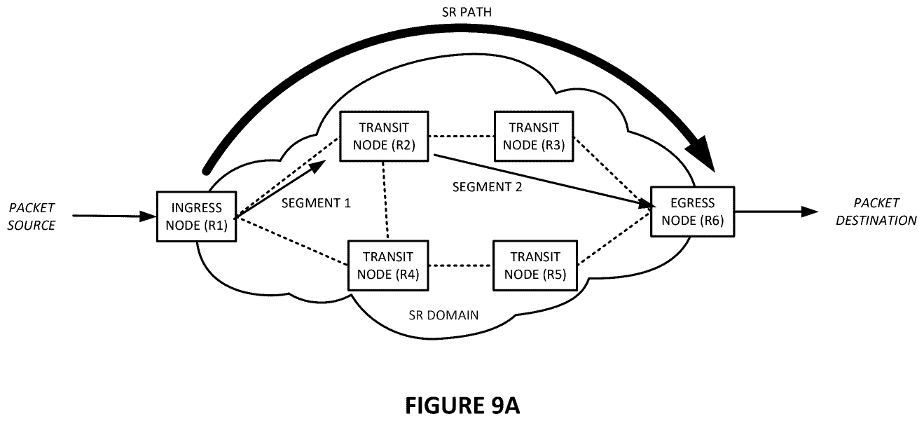

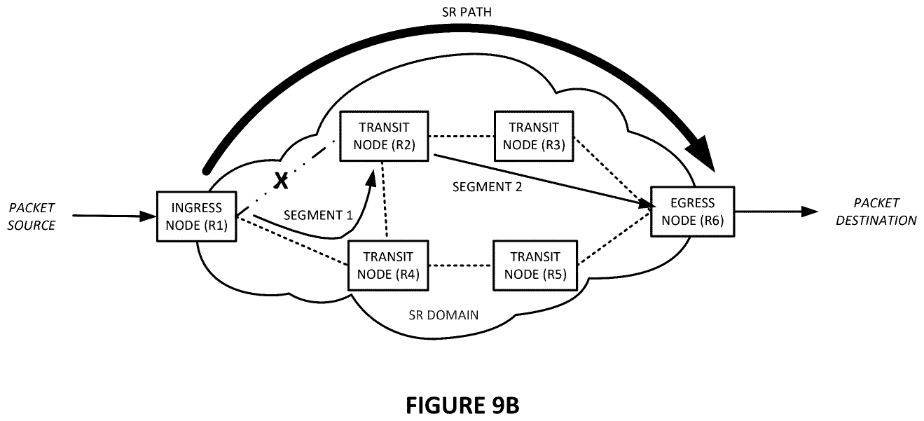

A prefix segment is an instruction that causes a packet to traverse the least cost path (or a path determined using an identified algorithm) to a node or prefix. Referring to FIG. 9A, assume that all links are configured with the same interior gateway protocol (IGP) metric and that the SR path is to be a least cost (and therefore) shortest path. An SR path connects ingress node R1 to egress node R6 and contains the following prefix segments: (1) segment 1, instantiated on R1, causes packets to traverse the least cost path from R1 to R2; (2) segment 2, instantiated on R2 and R3, causes packets to traverse the least cost path from the instantiating node to R6. Consequently, when the links are all available, the SR path guides packets through the above-mentioned links and segments.

Referring to FIG. 9B, assume that the link R1->R2 becomes unavailable. When this occurs, the network establishes a new least cost path between R1 and R2. This new least cost path includes Links R1->R4, and R4->R2. Since the network has established a new least cost path between R1 and R2, segment 1 remains available and causes packets to traverse the new least cost path. The behavior of segment 2 is unchanged. Therefore, the path now traverses Links R1->R4, R4->R2, R2->R3 and R3->R6.

Thus, a prefix segment is a multihop tunnel that uses equal cost multi-hop aware shortest (lowest cost) path links to reach a prefix. A prefix segment identifier (SID) supports both IPv4 and IPv6 prefixes. A node segment is a special case of prefix segment that uses shortest path links between two specific nodes.

### § 5.1.3 Comparing the First and Second Example Methods

A comparison of the first and second example methods is now provided. The first example method 300 is particularly useful when there are very few known nodes that are slow in programing the FIB. It is recommended that only those nodes be configured to advertise higher metrics for some time for a newly up link. In this way, convergence to less cost paths responsive to a link coming up isn't affected for all nodes (e.g., especially those nodes that are fast at FIB programming). Hence, such “fast” nodes can take advantage of links that are coming up immediately. Further, the first example method 300 still needs other nodes to implement micro-loop avoidance techniques (that is, MLA should be implemented on all nodes) because there could be micro-loops when the “inflated” cost metric of the newly up link drops back down to the actual cost metric. The second example method 400 is most useful when the network administrator is not sure as to which routers are slow in FIB programming (which is quite often the case in actual deployments), and one wants to avoid micro-loops and blackholing, irrespective. Note that the two examples are complementary, and both of them can be deployed in conjunction. If the first example method 300 is deployed, the link coming up will be advertised with a higher cost metric, and a node computing an MLA path will end up naturally avoiding the link having a high cost metric, and will not need to use additional SIDs to direct the traffic to avoid using the link coming up.

The first example method 300 is implemented by a node (e.g., a router) associated with the link (or link piece) that is coming up. One can think of this node as the node being the ultimate source or origin of the link state advertisement(s). The second example method 400 is implemented by a node(s) (e.g., a router(s)) receiving an advertisement of a link coming up.

### § 5.1.4 Example MLA Computation Procedure

This section describes an example MLA Solution; that is, an example procedure to compute guided path to destination to take the post-convergence path:
1. Compute the Directed Acyclic Graph (DAG) in the stable topology state (before any network event). Call this the “Pre-event DAG”.
2. Compute the DAG after the network event. Call this the “post-event DAG”.
3. Traverse the pre-event DAG. Compare the pre-event and post-event DAGs traversed to reach this node. If the DAGs are different, it means that SPF paths would be for nodes that have and haven't converged leading to potential micro-loops.
4. Use a SID to reach the parent of the node where the DAGs differ (Because we know that the DAGs are same until the parent, and hence all nodes will reach to the parent node using the same path irrespective of they have converged due to the network event.

### § 5.2 Example Apparatus

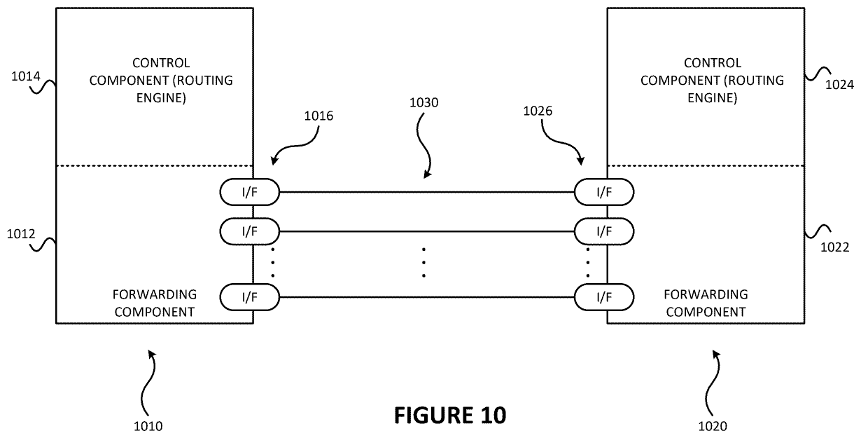

The data communications network nodes may be forwarding devices, such as routers for example. FIG. 10 illustrates two data forwarding systems 1010 and 1020 coupled via communications links 1030. The links may be physical links or “wireless” links. The data forwarding systems 1010,1020 may be routers for example. If the data forwarding systems 1010,1020 are example routers, each may include a control component (e.g., a routing engine) 1014,1024 and a forwarding component 1012,1022. Each data forwarding system 1010,1020 includes one or more interfaces 1016,1026 that terminate one or more communications links 1030.

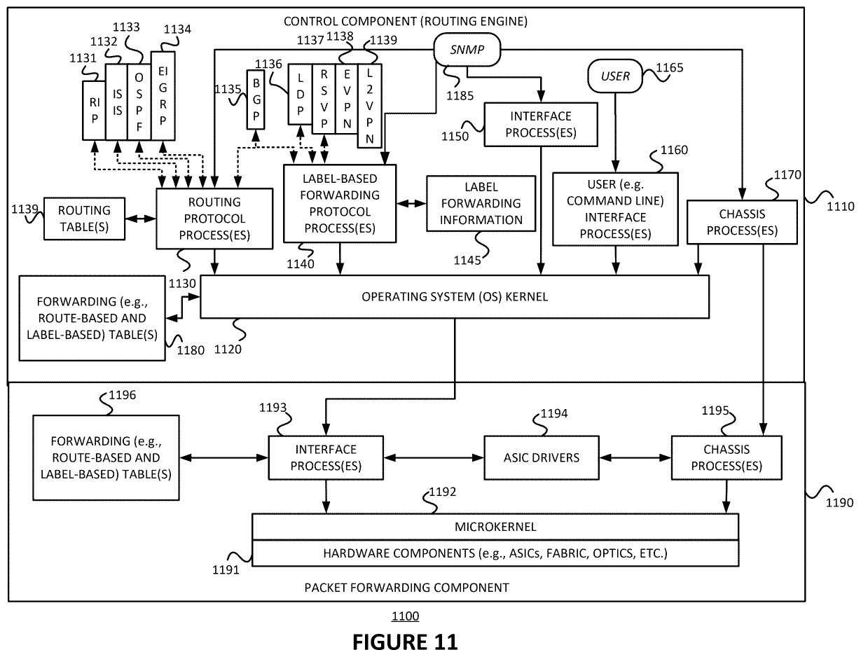

As just discussed above, and referring to FIG. 11, some example routers 1100 include a control component (e.g., routing engine) 1110 and a packet forwarding component (e.g., a packet forwarding engine) 1190.

The control component 1110 may include an operating system (OS) kernel 1120, routing protocol process(es) 1130, label-based forwarding protocol process(es) 1140, interface process(es) 1150, user interface (e.g., command line interface) process(es) 1160, and chassis process(es) 1170, and may store routing table(s) 1139, label forwarding information 1145, and forwarding (e.g., route-based and/or label-based) table(s) 1180. As shown, the routing protocol process(es) 1130 may support routing protocols such as the routing information protocol (“RIP”) 1131, the intermediate system-to-intermediate system protocol (“IS-IS”) 1132, the open shortest path first protocol (“OSPF”) 1133, the enhanced interior gateway routing protocol (“EIGRP”) 1134 and the border gateway protocol (“BGP”) 1135, and the label-based forwarding protocol process(es) 1140 may support protocols such as BGP 1135, the label distribution protocol (“LDP”) 1136, the resource reservation protocol (“RSVP”) 1137, EVPN 1138 and L2VPN 1139. One or more components (not shown) may permit a user 1165 to interact with the user interface process(es) 1160. Similarly, one or more components (not shown) may permit an outside device to interact with one or more of the router protocol process(es) 1130, the label-based forwarding protocol process(es) 1140, the interface process(es) 1150, and the chassis process(es) 1170, via SNMP 1185, and such processes may send information to an outside device via SNMP 1185.

The packet forwarding component 1190 may include a microkernel 1192 over hardware components (e.g., ASICs, switch fabric, optics, etc.) 1191, interface process(es) 1193, ASIC drivers 1194, chassis process(es) 1195 and forwarding (e.g., route-based and/or label-based) table(s) 1196.

In the example router 1100 of FIG. 11, the control component 1110 handles tasks such as performing routing protocols, performing label-based forwarding protocols, control packet processing, etc., which frees the packet forwarding component 1190 to forward received packets quickly. That is, received control packets (e.g., routing protocol packets and/or label-based forwarding protocol packets) are not fully processed on the packet forwarding component 1190 itself, but are passed to the control component 1110, thereby reducing the amount of work that the packet forwarding component 1190 has to do and freeing it to process packets to be forwarded efficiently. Thus, the control component 1110 is primarily responsible for running routing protocols and/or label-based forwarding protocols, maintaining the routing tables and/or label forwarding information, sending forwarding table updates to the packet forwarding component 1190, and performing system management. The example control component 1110 may handle routing protocol packets, provide a management interface, provide configuration management, perform accounting, and provide alarms. The processes 1130, 1140, 1150, 1160 and 1170 may be modular, and may interact with the OS kernel 1120. That is, nearly all of the processes communicate directly with the OS kernel 1120. Using modular software that cleanly separates processes from each other isolates problems of a given process so that such problems do not impact other processes that may be running. Additionally, using modular software facilitates easier scaling.

Still referring to FIG. 11, the example OS kernel 1120 may incorporate an application programming interface (“API”) system for external program calls and scripting capabilities. The control component 1110 may be based on an Intel PCI platform running the OS from flash memory, with an alternate copy stored on the router's hard disk. The OS kernel 1120 is layered on the Intel PCI platform and establishes communication between the Intel PCI platform and processes of the control component 1110. The OS kernel 1120 also ensures that the forwarding tables 1196 in use by the packet forwarding component 1190 are in sync with those 1180 in the control component 1110. Thus, in addition to providing the underlying infrastructure to control component 1110 software processes, the OS kernel 1120 also provides a link between the control component 1110 and the packet forwarding component 1190.

Referring to the routing protocol process(es) 1130 of FIG. 11, this process(es) 1130 provides routing and routing control functions within the platform. In this example, the RIP 1131, ISIS 1132, OSPF 1133 and EIGRP 1134 (and BGP 1135) protocols are provided. Naturally, other routing protocols may be provided in addition, or alternatively. Similarly, the label-based forwarding protocol process(es) 1140 provides label forwarding and label control functions. In this example, the LDP 1136, RSVP 1137, EVPN 1138 and L2VPN 1139 (and BGP 1135) protocols are provided. Naturally, other label-based forwarding protocols (e.g., MPLS, SR/SPRING, etc.) may be provided in addition, or alternatively. In the example router 1100, the routing table(s) 1139 is produced by the routing protocol process(es) 1130, while the label forwarding information 1145 is produced by the label-based forwarding protocol process(es) 1140.

Still referring to FIG. 11, the interface process(es) 1150 performs configuration of the physical interfaces and encapsulation.

The example control component 1110 may provide several ways to manage the router. For example, it 1110 may provide a user interface process(es) 1160 which allows a system operator 1165 to interact with the system through configuration, modifications, and monitoring. The SNMP 1185 allows SNMP-capable systems to communicate with the router platform. This also allows the platform to provide necessary SNMP information to external agents. For example, the SNMP 1185 may permit management of the system from a network management station running software, such as Hewlett-Packard's Network Node Manager (“HP-NNM”), through a framework, such as Hewlett-Packard's OpenView. Accounting of packets (generally referred to as traffic statistics) may be performed by the control component 1110, thereby avoiding slowing traffic forwarding by the packet forwarding component 1190.

Although not shown, the example router 1100 may provide for out-of-band management, RS-232 DB9 ports for serial console and remote management access, and tertiary storage using a removable PC card. Further, although not shown, a craft interface positioned on the front of the chassis provides an external view into the internal workings of the router. It can be used as a troubleshooting tool, a monitoring tool, or both. The craft interface may include LED indicators, alarm indicators, control component ports, and/or a display screen. Finally, the craft interface may provide interaction with a command line interface (“CLI”) 1160 via a console port, an auxiliary port, and/or a management Ethernet port.

The packet forwarding component 1190 is responsible for properly outputting received packets as quickly as possible. If there is no entry in the forwarding table for a given destination or a given label and the packet forwarding component 1190 cannot perform forwarding by itself, it 1190 may send the packets bound for that unknown destination off to the control component 1110 for processing. The example packet forwarding component 1190 is designed to perform Layer 2 and Layer 3 switching, route lookups, and rapid packet forwarding.

As shown in FIG. 11, the example packet forwarding component 1190 has an embedded microkernel 1192 over hardware components 1191, interface process(es) 1193, ASIC drivers 1194, and chassis process(es) 1195, and stores a forwarding (e.g., route-based and/or label-based) table(s) 1196. The microkernel 1192 interacts with the interface process(es) 1193 and the chassis process(es) 1195 to monitor and control these functions. The interface process(es) 1192 has direct communication with the OS kernel 1120 of the control component 1110. This communication includes forwarding exception packets and control packets to the control component 1110, receiving packets to be forwarded, receiving forwarding table updates, providing information about the health of the packet forwarding component 1190 to the control component 1110, and permitting configuration of the interfaces from the user interface (e.g., CLI) process(es) 1160 of the control component 1110. The stored forwarding table(s) 1196 is static until a new one is received from the control component 1110. The interface process(es) 1193 uses the forwarding table(s) 1196 to look up next-hop information. The interface process(es) 1193 also has direct communication with the distributed ASICs. Finally, the chassis process(es) 1195 may communicate directly with the microkernel 1192 and with the ASIC drivers 1194.

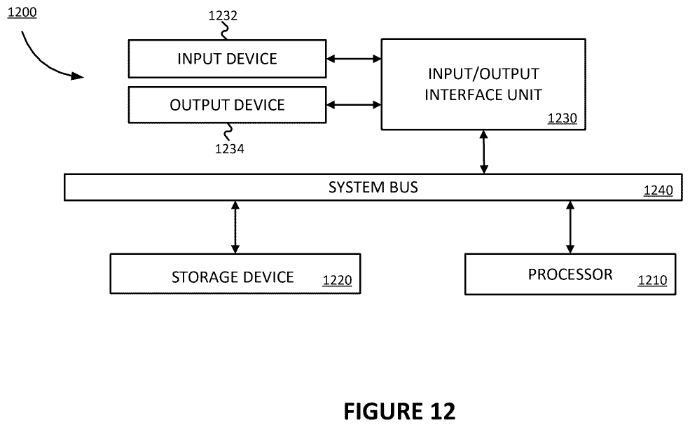

Although example embodiments consistent with the present description may be implemented on the example routers of FIG. 10 or 11, embodiments consistent with the present description may be implemented on communications network nodes (e.g., routers, switches, etc.) having different architectures. More generally, embodiments consistent with the present description may be implemented on an example system 1200 as illustrated on FIG. 12.

FIG. 12 is a block diagram of an exemplary machine 1200 that may perform one or more of the processes described, and/or store information used and/or generated by such processes. The exemplary machine 1200 includes one or more processors 1210, one or more input/output interface units 1230, one or more storage devices 1220, and one or more system buses and/or networks 1240 for facilitating the communication of information among the coupled elements. One or more input devices 1232 and one or more output devices 1234 may be coupled with the one or more input/output interfaces 1230. The one or more processors 1210 may execute machine-executable instructions (e.g., C or C++ running on the Linux operating system widely available from a number of vendors) to effect one or more aspects of the present description. At least a portion of the machine executable instructions may be stored (temporarily or more permanently) on the one or more storage devices 1220 and/or may be received from an external source via one or more input interface units 1230. The machine executable instructions may be stored as various software modules, each module performing one or more operations. Functional software modules are examples of components of the present description.

In some embodiments consistent with the present description, the processors 1210 may be one or more microprocessors and/or ASICs. The bus 1240 may include a system bus. The storage devices 1220 may include system memory, such as read only memory (ROM) and/or random access memory (RAM). The storage devices 1220 may also include a hard disk drive for reading from and writing to a hard disk, a magnetic disk drive for reading from or writing to a (e.g., removable) magnetic disk, an optical disk drive for reading from or writing to a removable (magneto-) optical disk such as a compact disk or other (magneto-) optical media, or solid-state non-volatile storage.

Some example embodiments consistent with the present description may also be provided as a machine-readable medium for storing the machine-executable instructions. The machine-readable medium may be non-transitory and may include, but is not limited to, flash memory, optical disks, CD-ROMs, DVD ROMs, RAMs, EPROMs, EEPROMs, magnetic or optical cards or any other type of machine-readable media suitable for storing electronic instructions. For example, example embodiments consistent with the present description may be downloaded as a computer program which may be transferred from a remote computer (e.g., a server) to a requesting computer (e.g., a client) by way of a communication link (e.g., a modem or network connection) and stored on a non-transitory storage medium. The machine-readable medium may also be referred to as a processor-readable medium.

Example embodiments consistent with the present description (or components or modules thereof) might be implemented in hardware, such as one or more field programmable gate arrays (“FPGA”s), one or more integrated circuits such as ASICs, one or more network processors, etc. Alternatively, or in addition, embodiments consistent with the present description (or components or modules thereof) might be implemented as stored program instructions executed by a processor. Such hardware and/or software might be provided in an addressed data (e.g., packet, cell, etc.) forwarding device (e.g., a switch, a router, etc.), a laptop computer, desktop computer, a tablet computer, a mobile phone, or any device that has computing and networking capabilities.

### § 5.3 Conclusions

As can be appreciated, the methods and devices described above allow the avoidance of micro-loops and black holing in an IGP domain in which a link is newly UP.

What is claimed is:

1. A computer-implemented method for avoiding micro-loops and black holing in an interior gateway protocol (IGP) domain in which a link is newly UP, the computer-implemented method comprising:
a) treating the newly UP link as either (A) unusable or (B) as having a very high cost metric, until a delay condition occurs, such that forwarding through the newly UP link is avoided until the delay condition occurs;
b) determining whether or not the delay condition occurs; and
c) responsive to a determination that the delay condition occurs, treating the newly UP link as usable, and using an actual cost metric for the newly UP link.

2. The computer-implemented method of claim 1, wherein the delay condition is an expiration of a timer.

3. The computer-implemented method of claim 2, wherein the timer is configured to expire in at least 30 seconds.

4. The computer-implemented method of claim 1, wherein the delay condition is the receipt of a control plane message indicating that one or more nodes in the IGP domain has programmed their forwarding information base (FIB) with the newly UP link.

5. A computer-implemented method for avoiding micro-loops and black holing in an interior gateway protocol (IGP) domain in which a link is newly UP, the computer-implemented method comprising:
a) determining a guided path that avoids the newly UP link;
b) determining whether or not a delay condition occurs; and
c) responsive to a determination that the delay condition occurs, removing the guided path.

6. The computer-implemented method of claim 5, wherein the guided path tunnels packets towards a destination, up to a node that will forward the packets via a shortest path first (SPF) path towards the destination without looping back the packets.

7. The computer-implemented method of claim 5, wherein the guided path includes at least one prefix/node segment to a node that will forward packets via a shortest path first (SPF) path towards a destination without looping back the packets.

8. The computer-implemented method of claim 5, wherein the delay condition is the expiration of a configurable timer.

9. The computer-implemented method of claim 8 wherein the configurable timer is configured to expire in at least 30 seconds.

10. The computer-implemented method of claim 5, wherein the delay condition is the receipt of a control plane message indicating that one or more nodes in the IGP domain has programmed their forwarding information base (FIB) with the newly UP link.

11. The computer-implemented method of claim 5, wherein the guided path includes at least one segment routing (SR) segment.

12. A computer-implemented method for avoiding micro-loops and black holing in an interior gateway protocol (IGP) domain in which a network change event occurs, the computer-implemented method comprising:
a) responsive to a determination that a link in the IGP domain is newly down, determining a temporary micro-loop avoidance (MLA) path using a first procedure; and
b) responsive to a determination that a link in the IGP domain is newly up, determining a temporary micro-loop avoidance (MLA) path using a second procedure which is different than the first procedure.

13. The computer-implemented method of claim 12, wherein the second procedure includes
treating the newly UP link as either (A) unusable or (B) as having a very high cost metric, until a delay condition occurs, such that forwarding through the newly UP link is avoided until the delay condition occurs,
determining whether or not the delay condition occurs; and
responsive to a determination that the delay condition occurs, treating the newly UP link as usable, and using an actual cost metric for the newly UP link.

14. The computer-implemented method of claim 13, wherein the second procedure includes
determining a guided path that avoids the newly UP link,
determining whether or not a delay condition occurs, and
responsive to a determination that the delay condition occurs, removing the guided path.

15. The computer-implemented method of claim 14, wherein the guided path tunnels packets towards a destination, up to a node that will forward the packets via a shortest path first (SPF) path towards the destination without looping back the packets.

16. The computer-implemented method of claim 14, wherein the guided path includes at least one prefix/node segment to a node that will forward packets via a shortest path first (SPF) path towards a destination without looping back the packets.

17. The computer-implemented method of claim 14 wherein the guided path includes at least one segment routing (SR) segment.
